(19) United States
(12) Patent Application Publication
(10) Pub. No.: US 2009/0105398 A1
(43) Pub. Date: Apr. 23, 2009

(54) Rubber Composition For Pneumatic Tire

(75) Inventor: Kazuya Hirabayashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/254,130

(22) Filed: Oct. 20, 2008

(30) Foreign Application Priority Data
Oct. 22, 2007 (JP) 2007-273805

(51) Int. Cl. C08L 83/06; C08L 9/06; C08L 47/00; B60C 1/00

(52) U.S. Cl. 524/506; 525/237; 524/526

(57) ABSTRACT

A rubber composition for a pneumatic tire which improves workability of rubber processing and heat generation characteristics, and further improves driveability on dry pavement while maintaining grip performance is provided. The rubber composition for a pneumatic tire includes a rubber component comprising a copolymer rubber having a glass transition point of −40° C. or higher obtained by copolymerization of 1,3-butadiene with styrene using an organic lithium compound as an initiator, alone or a blend of 50% by weight or more of the copolymer rubber and 50% by weight or less of other diene rubber, silica and a silane coupling agent, and further includes a polymer gel which is diene polymer particles having a toluene swelling index Qi of less than 16 and a glass transition point of from 20 to 80° C. in an amount of from 1 to 30 parts by weight per 100 parts by weight of the rubber component.

### CROSS-REFERENCE TO RELATED APPLICATIONS

This application is based upon and claims the benefit of priority from the prior Japanese Patent Application No. 2007-273805, filed on Oct. 22, 2007; the entire contents of which are incorporated herein by reference.

### BACKGROUND

The present invention relates to a rubber composition for a pneumatic tire.

Grip performance, braking performance and driveability on dry pavement and wet pavement are required in high level in a pneumatic tire, particularly a high performance tire.

In generally, a technique of increasing a compounding amount of a filler and an oil is used to improve grip performance on wet pavement and dry pavement. In such a case, heat build-up and abrasion resistance are decreased. Furthermore, viscosity in an unvulcanized state is elevated and dispersibility of a filler deteriorates. As a result, to obtain sufficient performance, the number of mixing is increased, resulting deterioration of workability. Using a polymer having high glass transition point as a rubber component is considered as other technique. Such a case leads to deterioration of heat build-up and abrasion resistance, and due to deterioration of temperature dependency, deterioration of driveability on dry pavement is induced.

To improve grip performance on wet pavement, silica is generally used. However, when silica is used, workability greatly deteriorates, such as increase of the number of mixing or decrease of extrusion speed. To such problems, blocked mercaptosilane is compounded as a silane coupling agent, and this makes it possible to improve incorporation of silica in a rubber component during mixing and dispersibility of silica while maintaining grip performance on wet pavement and dry pavement, thereby improving workability and heat generation characteristics (see WO99/09036, the entire contents of this reference being incorporated herein by reference). However, due to improvement of dispersibility of silica, hardness and dynamic modulus E′ are decreased, and as a result, there is fear of deterioration of driveability on dry pavement.

On the other hand, as a technique to improve driveability on dry pavement, it is considered to increase rubber hardness by, for example, increasing the amount of a filler, decreasing the amount of an oil or adding a hardener. In such a case, grip performance on wet pavement deteriorates (see JP-A-2006-225448 (kokai), the entire contents of this reference being incorporated herein by reference).

U.S. Pat. No. 6,184,296 B1 discloses a composition comprising a mixture of a rubber gel modified with a compound containing sulfur and having reactivity to C═C double bond and a diene rubber as a rubber composition for a tire tread having low rolling resistance.

WO 2002/102890 (the entire contents of this references being incorporated herein by reference) discloses a rubber composition comprising a solution polymerized styrene-butadiene rubber having compounded therewith silica, carbon black and a rubber gel for the purpose of improving slip resistance on wet pavement and rolling resistance and further for the purpose of improving abrasion resistance.

JP-A-2006-282837 (kokai) (the entire contents of this reference being incorporated herein by reference) discloses a rubber composition for a tire tread, comprising from 55 to 95 parts by weight of a diene rubber, from 5 to 45 parts by weight of a diene rubber gel having a toluene swelling index of from 16 to 70 and from 75 to 133 parts by weight of carbon black in order to combine high grip performance and good heat-resistant sag resistance.

Those references disclose to compound a rubber gel (polymer gel) in a rubber composition for a tire, but do not disclose to use a polymer gel having high glass transition point as in the present invention, and do not suggest that driveability on dry pavement can be improved by the addition of a rubber gel without impairing other characteristics.

### SUMMARY

The present invention has been made in view of the above circumstances. An aspect of the present invention is to improve workability of rubber processing and heat generation characteristics, and further improve driveability on dry pavement while maintaining grip performance by using a specific polymer gel.

According to the aspect of the present invention, there is provided a rubber composition for a pneumatic tire, comprising a rubber component comprising a copolymer rubber having a glass transition point of −40° C. or higher obtained by copolymerization of 1,3-butadiene with styrene using an organic lithium compound as an initiator, alone or a blend of 50% by weight or more of the copolymer rubber and 50% by weight or less of other diene rubber, silica and a silane coupling agent, and further comprising a polymer gel which is diene polymer particles having a toluene swelling index Qi of less than 16 and a glass transition point of from 20 to 80° C. in an amount of from 1 to 30 parts by weight per 100 parts by weight of the rubber component. According to other aspect of the present invention, there is provided a pneumatic tire having a tread comprising the rubber composition.

According to the aspects of the present invention, by compounding silica as a filler and a silane coupling agent with a styrene-butadiene rubber having high glass transition point and further compounding a specific polymer gel, workability of rubber processing and heat generation characteristics can be improved, and additionally driveability on dry pavement can be improved, while maintaining grip performance.

### DETAILED DESCRIPTION

The embodiments of the present invention are described in detail below.

In the rubber composition according to the aspect of the present invention, a copolymer rubber used as a rubber component is a styrene-butadiene rubber (SBR) obtained by copolymerization of 1,3-butadiene with styrene using an organic lithium compound as an initiator, that is, a solution polymerized SBR. The copolymer rubber can be produced by the conventional solution polymerization method using an inert organic solvent such as pentane, hexane, heptane, benzene, toluene or diethyl ether. Examples of the organic lithium compound include alkyl lithium such as n-butyl lithium; alkylene dilithium such as 1,4-dilithium butane; and phenyl lithium. The copolymer rubber may be that chain ends of the copolymer are treated with a tin coupling agent, a silicon coupling agent or an alkoxysilane coupling agent, or alternatively ends or main chain are modified with a functional group (such as hydroxyl group or amino group) having interaction and chemical reactivity with silanol group of silica.

The copolymer rubber used is a copolymer rubber having a glass transition point (Tg) of −40° C. or higher. The grip performance on wet pavement and dry pavement can be improved by using the copolymer rubber having high glass transition point. The upper limit of the glass transition point is not particularly limited, but generally is 0° C. or lower. The glass transition point used herein is a value measured using differential scanning calorimetry (DSC) according to JIS K7121 (temperature rising rate: 20° C./min).

The rubber component in the rubber composition comprises the copolymer rubber alone, or a blend of 50% by weight or more of the copolymer rubber and 50% by weight or less of other diene rubber. Where the proportion of the copolymer rubber is less than 50% by weight, the advantage of the present invention described above cannot sufficiently be exhibited. The other diene rubber is not particularly limited, and examples thereof include a natural rubber, and synthetic diene rubbers such as a styrene-butadiene rubber other than the above copolymer rubber, an isoprene rubber, a butadiene rubber, a styrene-isoprene copolymer rubber, a butadiene-isoprene copolymer rubber, a styrene-isoprene-butadiene copolymer rubber or a nitrile rubber. Those may be used alone or as mixtures of two or more thereof.

The silica used in the rubber composition is not particularly limited. Examples of the silica include wet silica, dry silica, colloidal silica and precipitated silica. In particular, wet silica comprising hydrous silicic acid as a main component is preferably used. The silica is preferably compounded in an amount of from 20 to 100 parts by weight per 100 parts by weight of the rubber component. The more preferred compounding amount of the silica is that the lower limit is 40 parts by weight and the upper limit is 90 parts by weight. Where the compounding amount of the silica is less than 20 parts by weight, it is difficult to obtain a sufficient improvement effect of grip performance.

In the rubber composition according to the aspect of the present invention, the filler may be the silica alone, but carbon black may be compounded together with the silica. The carbon black is preferably compounded in an amount of from 0 to 100 parts by weight per 100 parts by weight of the rubber component. Furthermore, the silica and the carbon black are preferably compounded in the total amount of from 70 to 150 parts by weight. In the rubber composition, other than the above silica and carbon black, other fillers such as titanium oxide, aluminum silicate, clay or talc can be compounded as the filler.

The silane coupling agent used in the rubber composition generally acts to bond silica and a rubber component. In the present invention, it is considered that the silane coupling agent develops a function to increase hardness of the rubber composition by reacting or crosslinking the same with a polymer gel.

The silane coupling agent is an organic silane compound having an organic moiety capable of reacting with a polymer, such as a sulfide, an amino group, a mercapto group, a vinyl group, a methacryl group or an epoxy group, and a halogen, an alkoxy group or the like, and the conventional various silane coupling agents can be used. Preferably, a sulfide silane represented by the following formula (1), or a blocked mercaptosilane represented by the following formula (2) is used.

(C₂H₅O)₃Si—C_{y}H_{2y}—Sₓ—C_{y}H_{2y}—Si(OC₂H₅)₃ (1)

(CₙH₂ₙ₊₁O)₃Si—CₘH₂ₘ—S—CO—CₖH₂ₖ₊₁ (2)

In the formula (1), y is an integer of from 1 to 9, and preferably from 2 to 5; and x is from 1 to 4, and preferably from 2 to 4. In detail, x generally has distribution, that is, the sulfide silane is commercially available as a mixture of compounds having different number of sulfur chain bonds, and x shows its average value. Specific examples of the preferred sulfide silane represented by the formula (1) include bis(3-triethoxysilylpropyl)tetrasulfide, bis(3-triethoxysilylpropyl)disulfide and bis(2-triethoxysilylethyl)tetrasulfide.

In the formula (2), n is an integer of from 1 to 2, m is an integer of from 1 to 5 and k is an integer of from 5 to 9. The blocked mercaptosilane represented by the formula (2) can be produced according to the method described in WO 99/09036. As the preferred example, a blocked mercaptosilane represented by the formula (2) wherein n=2, m=3 and k=7 is sold as NXT from GE Silicones.

The compounding amount of the silane coupling agent is preferably from 2 to 25 parts by weight, and more preferably from 5 to 15 parts by weight, per 100 parts by weight of the silica, in the point of sufficiently exhibiting the advantages of the present invention described above.

A polymer gel which is specific diene polymer particles is compounded with the rubber composition. The polymer gel can be produced by crosslinking a rubber dispersion. Examples of the rubber dispersion include a rubber latex produced by an emulsion polymerization, and a rubber dispersion obtained by emulsifying a solution polymerized rubber in water. Examples of the crosslinking agent include an organic peroxide, an organic azo compound and a sulfur crosslinking agent. The crosslinking of rubber particles can be conducted by copolymerization with a polyfunctional compound having a crosslinking action during emulsion polymerization of a rubber. Specifically, the methods described in, for example, U.S. Pat. No. 6,184,296 B1, U.S. Pat. No. 5,395,891, WO 02/08328 or WO 02/12389 (the entire contents of those references being incorporated herein by reference) can be used.

The diene polymer constituting the polymer gel includes various diene rubbers described above. Those can be used alone or as mixtures of two or more thereof. In particular, a diene polymer comprising a styrene-butadiene rubber (SBR) as a main component is preferred.

The polymer gel used in the present invention has a toluene swelling index Qi of less than 16. The toluene swelling index Qi is more preferably from 1 to 15, and further preferably from 3 to 8. Where the toluene swelling index Qi is less than 1, hardness of particles is high, and as a result, workability at the time of processing and rubber properties may be impaired. On the other hand, Qi is 16 or more, reinforcing effect of particles is deficient. As a result, driveability deteriorates, and additionally adverse influence is given to other tire characteristics such as abrasion resistance. The gel content in the polymer gel is not particularly limited, but is preferably 94% by weight or more.

The toluene swelling index and the gel content are measured by swelling a polymer gel in toluene, and then drying. Specifically, 250 mg of a polymer gel is swollen in 25 ml of toluene for 24 hours under shaking. The swollen polymer gel is centrifuged at 20,000 rpm. Its wet mass is weighed and then dried at 70° C. until the mass becomes constant, and a dry mass is weighed. The gel content is a weight proportion (%) of a polymer gel after drying to the polymer gel used. The toluene swelling index is obtained by Qi=(wet mass of gel)/(dry mass of gel).

The polymer gel used in the present invention has a glass transition point (Tg) of from 20 to 80° C. The glass transition point is preferably from 40 to 80° C., and more preferably from 50 to 70° C. By using a polymer gel having high glass transition point, hardness of the rubber composition is effectively increased, and as a result, driveability on dry pavement can be improved. The glass transition point is a value measured using differential scanning calorimetry (DSC) according to JIS K7121 (temperature rising rate: 20° C./min).

The polymer gel preferably used is a polymer gel modified with a compound having OH (hydroxyl) group. The polymer gel comprises a diene polymer, and has C═C double bond on the surface of particles. Therefore, by using a compound having OH group and additionally having reactivity to C═C double bond, OH group can be incorporated on the surface of particles.

Examples of such a compound (modifier) include hydroxyalkyl(meth)acrylates such as hydroxybutyl acrylate or methacrylate, hydroxyethyl acrylate or methacrylate, and hydroxypropyl acrylate or methacrylate, as described in WO 02/12389.

A particle diameter of the polymer gel is not particularly limited, but a polymer gel having an average particle diameter (DVN value according to DIN 53 206) of from about 20 to 600 nm is preferably used.

By compounding such a polymer gel, the following functions and advantages are exhibited. That is, the polymer gel has high glass transition point as above, and as a result, contributes to effective increase of hardness in a state of being used in a tire. The polymer gel has double bonds on the surface thereof, and as a result, can react and crosslink with a silane coupling agent. Therefore, the polymer gel and silica can be bonded through a silane coupling agent. Hardness is increased from this point. As a result, driveability on dry pavement can effectively be increased. In particular, when the polymer gel is modified with a compound having OH group, the OH group as a functional group present on the surface reacts with a silane coupling agent, and the polymer gel and the rubber component can be bonded through the silane coupling agent. As a result, further increase of hardness is promoted, and driveability on dry pavement can further been improved. Furthermore, the OH group can be interacted with a silanol group on the silica surface, and performance improvement is promoted from this point.

The polymer gel is compounded in an amount of from 1 to 30 parts by weight, and preferably from 3 to 20 parts by weight, per 100 parts by weight of the rubber component. Where the compounding amount of the polymer gel is too small, the above-described effects are insufficient. On the other hand, where the compounding amount of the polymer gel is too large, grip performance on wet pavement is impaired.

Other than the components described above, various additives generally used in a rubber composition for a tire, such as softeners, plasticizers, age resisters, zinc white, stearic acid, vulcanizing agents or vulcanization accelerators can be compounded with the rubber composition according to the aspect of the present invention.

The rubber composition comprising the above constitution is preferably used as a rubber composition for a tread of a pneumatic tire, particularly a high performance pneumatic tire (for example, a racing tire), and can form the tread by vulcanization molding according to the conventional method.

### EXAMPLES

The embodiments of the present invention are described below, but the invention is not limited to those embodiments.

### First Embodiment

Using Banbury mixer, a rubber composition for a tire tread was prepared according to the formulation shown in Table 1. Each component in Table 1 is as follows.

SBR1: Solution polymerized SBR, VSL5025-OHM (glass transition point Tg: −15° C.), manufactured by Lanxess

SBR2: SBR1502 (glass transition point Tg: −66° C.), manufactured by JSR Corporation

Carbon black: DIABLACK N234, manufactured by Mitsubishi Chemical Corporation

Silica: ULTRASIL 7000GR (BET specific surface area: 170 m²/g, CTAB specific surface area: 160 m²/g), manufactured by Degussa

Silane coupling agent: bis-(3-triethoxysilylpropyl)-disulfide, Si-75, manufactured by Degussa

Polymer gel 1: MICROMOF Mn 1 (polymer gel based on SBR, toluene swelling index Qi: 7, gel content: 96% by weight, Tg: 65° C., OH group-modified product), manufactured by Rhein Chemie

Polymer gel 2: MICROMOF Mn 4 (polymer gel based on SBR, toluene swelling index Qi: 6, gel content: 97% by weight, Tg: −15° C., OH group-modified product), manufactured by Rhein Chemie

As the common formulation, 40 parts by weight of an aroma type process oil (JOMO PROCESS NC-140, manufactured by Japan Energy Corporation), 2 parts of stearic acid (RUNAX S-20, manufactured by Kao Corporation), 3 parts by weight of zinc white (Zinc White #1, manufactured by Mitsui Mining & Smelting Co., Ltd.), 2 parts by weight of an age resister (SANTOFLEX 6PPD, manufactured by FLEXSYS), 2 parts by weight of a wax (OZOACE 0355, manufactured by Nippon Seiro Co., Ltd.), 1.5 parts by weight of a vulcanization accelerator (NOCCELLAR CZ-G, manufactured by Ouchi Shinko Chemical Industrial Co., Ltd.) and 2.1 parts by weight of sulfur (powdery sulfur 150 mesh, manufactured by Hosoi Chemical Industry Co., Ltd.) were compounded with 100 parts by weight of a rubber component in each rubber composition.

Processability and heat generation characteristics of each rubber composition obtained were evaluated, and a pneumatic radial tire was prepared using each rubber composition. The tire had a size of 225/45ZR17, and each rubber composition was applied to its tread, and vulcanization molded according to the conventional method to produce a tire. Grip performance (wet grip property) on wet pavement and driveability on dry pavement of each tire obtained were evaluated. Each evaluation method is as follows.

Processability: Processability was evaluated by a Mooney viscosity measured with a Mooney viscometer, manufactured by Shimadzu Corporation. The test method was according to JIS K6300. The processability was indicated in an inverse index as the value of Comparative Example 1 being 100. Viscosity is low and processability is good as the value is large.

Heat generation characteristics: Heat generation characteristics were evaluated by temperature rise measured with a constant stress flexometer, manufactured by Ueshima Seisakusho Co., Ltd. The test method was according to JIS K6265. The heat generation characteristics were indicated in an inverse index as Comparative Example 1 being 100. Generation of heat is difficult to cause and heat generation characteristics are good as the value is large.

Wet grip property: Four tires obtained above were used in a 2500 cc sedan, and the sedan was run on a road surface on which water was sprayed in a depth of 2 to 3 mm. Friction coefficient was measured at 100 km per hour, and wet grip property was evaluated. The wet grip property was indicated by an index as the value of Comparative Example 1 being 100. The grip performance is good as the value is large.

Driveability on dry pavement: Four tires obtained above were used in a 2500 cc sedan, and a driver in charge of a sensory test drove the car on a test course at high speed while paying attention to steering responsiveness, running stability and the like, and evaluated driveability. The results were indicated that as compared with Comparative Example 1 as control, excellent driveability was indicated “+2”, slightly excellent driveability was indicated “+1”, comparable driveability was indicated “±0”, slightly poor driveability was indicated “−1”, and poor driveability was indicated “−2”.

TABLE 1

| | | Comparative | Comparative | | | | | Comparative | Comparative |
|---|---|---|---|---|---|---|---|---|---|
| | | Example 1 | Example 2 | Example 1 | Example 2 | Example 3 | Example 4 | Example 3 | Example 4 |
| Compounding | SBR1 | 60 | 60 | 60 | 60 | 60 | 60 | 60 | 60 |
| amount | (Tg: −15° C.) | | | | | | | | |
| (parts | SRB2 | 40 | 40 | 40 | 40 | 40 | 40 | 40 | 40 |
| by weight) | (Tg: −66° C.) | | | | | | | | |
| | Carbon black | 20 | 20 | 20 | 20 | 20 | 20 | 20 | 20 |
| | Silica | 70 | 70 | 70 | 70 | 70 | 70 | 70 | 70 |
| | Silane | 6 | 6 | 6 | 6 | 6 | 6 | 6 | 6 |
| | coupling agent | | | | | | | | |
| | Polymer gel 1 | | | 5 | 15 | 2 | 25 | 0.3 | 50 |
| | (Tg: 65° C.) | | | | | | | | |
| | Polymer gel 2 | | 5 | | | | | | |
| | (Tg: −15° C.) | | | | | | | | |

| | | | | | | | | |
|---|---|---|---|---|---|---|---|---|
| Processability | 100 | 98 | 102 | 104 | 101 | 105 | 100 | 102 |
| Heat generation | 100 | 103 | 105 | 108 | 101 | 110 | 100 | 113 |
| characteristics | | | | | | | | |
| Wet grip property | 100 | 98 | 102 | 101 | 100 | 99 | 99 | 95 |
| Driveability | ±0 | −1 | +1 | +2 | +1 | +2 | ±0 | +1 |

The results are shown in Table 1 above, and according to the embodiments of the present invention, processability, heat generation characteristics and driveability on dry pavement could be improved while maintaining wet grip property, as compared with Comparative Examples 1 as a control. On the other hand, in Comparative Example 2 in which a polymer gel is compounded but its glass transition point is high, an effect of improving driveability on dry pavement was not obtained.

### Second Embodiment

Using Banbury mixer, a rubber composition for a tire tread was prepared according to the formulation shown in Table 2 below. Each component in Table 2 is as follows.

SBR3: Solution polymerized SBR, TUFDENE E50 (glass transition point Tg: −30° C.), manufactured by Asahi Kasei Corporation

Silica: NIPSEAL AQ (BET specific surface area: 210 m²/g, CTAB specific surface area: 170 m²/g), manufactured by Tosoh Silica Corporation

SBR2, carbon black, silane coupling agent, polymer gel 1 and polymer gel 2 are the same as in First Embodiment.

The same additives as in First Embodiment were compounded as the common formulation with each rubber composition. Regarding each rubber composition obtained, processability and heat generation characteristics were evaluated in the same manners as in First Embodiment. Furthermore, a pneumatic radial tire was prepared using each rubber composition, and grip performance (wet grip property) on wet pavement and driveability on dry pavement were evaluated. Each evaluation method is the same as in First Embodiment above. However, in each test item, Comparative Example 5 was used as a control, and processability, heat generation characteristics and wet grip property were indicated by an index as the value of Comparative Example 5 being 100. Driveability was indicated in five grades of from −2 to +2 in the comparison with Comparative Example 5.

TABLE 2

| | | Comparative | Comparative | | | | | Comparative | Comparative |
|---|---|---|---|---|---|---|---|---|---|
| | | Example 5 | Example 6 | Example 5 | Example 6 | Example 7 | Example 8 | Example 7 | Example 8 |
| Compounding | SBR3 | 80 | 80 | 80 | 80 | 80 | 80 | 80 | 80 |
| amount | (Tg: −30° C.) | | | | | | | | |
| (parts | SRB2 | 20 | 20 | 20 | 20 | 20 | 20 | 20 | 20 |
| by weight) | (Tg: −66° C.) | | | | | | | | |
| | Carbon black | 20 | 20 | 20 | 20 | 20 | 20 | 20 | 20 |
| | Silica | 70 | 70 | 70 | 70 | 70 | 70 | 70 | 70 |
| | Silane | 6 | 6 | 6 | 6 | 6 | 6 | 6 | 6 |
| | coupling agent | | | | | | | | |
| | Polymer gel 1 | | | 5 | 15 | 2 | 25 | 0.3 | 50 |
| | (Tg: 65° C.) | | | | | | | | |
| | Polymer gel 2 | | 5 | | | | | | |
| | (Tg: −15° C.) | | | | | | | | |

| | | | | | | | | |
|---|---|---|---|---|---|---|---|---|
| Processability | 100 | 97 | 102 | 104 | 101 | 104 | 100 | 102 |
| Heat generation | 100 | 102 | 105 | 107 | 101 | 110 | 100 | 112 |
| characteristics | | | | | | | | |
| Wet grip property | 100 | 97 | 101 | 101 | 100 | 100 | 98 | 93 |
| Driveability | ±0 | −1 | +1 | +2 | +1 | +2 | ±0 | +1 |

The results are shown in Table 2 above, and the same tendency as in First Embodiment was observed.

The rubber composition for a pneumatic tire according to the aspect of the present invention can preferably be used in a tread of a pneumatic tire, and is particularly preferred as a tread rubber of a high performance radial tire.

What is claimed is:

1. A rubber composition for a pneumatic tire, comprising a rubber component comprising a copolymer rubber having a glass transition point of −40° C. or higher obtained by copolymerization of 1,3-butadiene with styrene using an organic lithium compound as an initiator, alone or a blend of 50% by weight or more of the copolymer rubber and 50% by weight or less of other diene rubber, silica and a silane coupling agent, and
further comprising a polymer gel which is diene polymer particles having a toluene swelling index Qi of less than 16 and a glass transition point of from 20 to 80° C. in an amount of from 1 to 30 parts by weight per 100 parts by weight of the rubber component.

2. The rubber composition for a pneumatic tire as claimed in claim 1, wherein an amount of the silica is from 20 to 100 parts by weight per 100 parts by weight of the rubber component.

3. The rubber composition for a pneumatic tire as claimed in claim 2, wherein an amount of the silane coupling agent is from 2 to 25 parts by weight per 100 parts by weight of the silica.

4. The rubber composition for a pneumatic tire as claimed in claim 1, wherein the silane coupling agent is a sulfide silane represented by the following formula (1) or a blocked mercaptosilane represented by the following formula (2);
(C₂H₅O)₃Si—C_{y}H_{2y}—Sₓ—C_{y}H_{2y}—Si(OC₂H₅)₃ (1)
(CₙH₂ₙ₊₁O)₃Si—CₘH₂ₘ—S—CO—CₖH₂ₖ₊₁ (2)
wherein y is an integer of from 1 to 9, x is from 1 to 4, n is an integer of from 1 to 2, m is an integer of from 1 to 5 and k is an integer of from 5 to 9.

5. The rubber composition for a pneumatic tire as claimed in claim 1, wherein the polymer gel is a polymer gel modified with a compound having hydroxyl group.

6. A pneumatic tire having a tread comprising the rubber composition as claimed in claim 1.

7. A pneumatic tire having a tread comprising the rubber composition as claimed in claim 2.

8. A pneumatic tire having a tread comprising the rubber composition as claimed in claim 3.

9. A pneumatic tire having a tread comprising the rubber composition as claimed in claim 4.

10. A pneumatic tire having a tread comprising the rubber composition as claimed in claim 5.
